(19) United States
(12) Patent Application Publication
(10) Pub. No.: US 2016/0360108 A1
(43) Pub. Date: Dec. 8, 2016

(54) HIT-TRIGGERED IMAGE CAPTURING DEVICE

(71) Applicant: DIGILIFE TECHNOLOGIES CO., LTD., Taipei City (TW)

(72) Inventor: CHEN-PING YANG, TAIPEI CITY (TW)

(21) Appl. No.: 14/732,227

(22) Filed: Jun. 5, 2015

(51) Int. Cl. H04N 5/232

(52) U.S. Cl. CPC H04N 5/23258; H04N 5/23241

(57) ABSTRACT

A hit-triggered image capturing device includes a central processing portion; an image capturing portion electrically connected to the central processing portion; a hit-susceptible portion which includes a hit-susceptible body and a vibration sensing unit, wherein the vibration sensing unit is fixed to the hit-susceptible body and electrically connected to the central processing portion to thereby start the image capturing portion; a memory portion electrically connected to the central processing portion to store images captured by the image capturing portion; and a power supply portion electrically connected to the central processing portion. Therefore, the hit-triggered image capturing device captures real-time images when hit or vibrated.

### FIELD OF THE INVENTION

The present invention relates to hit-triggered image capturing devices and more particularly to a hit-triggered image capturing device which captures real-time images when hit or vibrated.

### BACKGROUND OF THE INVENTION

For a conventional image capturing device, such as a cellular phone, a digital camera, a digital camcorder, a car camcorder or a life camcorder, to capture images, a user must start a power source and then press a picture-taking button or a video-shooting button. However, the aforesaid process is not only time-consuming but also predisposed to missing an important moment worthy of being captured in images especially about a moving scene or an instantaneous event. Accordingly, it is necessary to provide an image capturing device which captures real-time images when hit or vibrated.

### SUMMARY OF THE INVENTION

In view of the aforesaid drawbacks of the prior art, the inventor of the present invention conceived room for improvement in the prior art and thus conducted extensive researches and experiments according to the inventor's years of experience in the related industry, and finally developed a hit-triggered image capturing device as disclosed in the present invention and characterized in that the hit-triggered image capturing device captures real-time images when hit or vibrated.

In order to achieve the above and other objectives, the present invention provides a hit-triggered image capturing device which comprises: a central processing portion; an image capturing portion electrically connected to the central processing portion; a hit-susceptible portion comprising a hit-susceptible body and a vibration sensing unit, wherein the vibration sensing unit is fixed to the hit-susceptible body and electrically connected to the central processing portion to thereby start the image capturing portion; a memory portion electrically connected to the central processing portion to store images captured by the image capturing portion; and a power supply portion electrically connected to the central processing portion.

As regards the hit-triggered image capturing device, the central processing portion comprises a hit counter.

As regards the hit-triggered image capturing device, the central processing portion comprises a hit force calculator.

As regards the hit-triggered image capturing device, the memory portion comprises an internal memory, an external memory, or a combination thereof.

As regards the hit-triggered image capturing device, the power supply portion comprises an internal power source, an external power source, or a combination thereof.

As regards the hit-triggered image capturing device, the vibration sensing unit is a G-Sensor.

Accordingly, the hit-triggered image capturing device of the present invention captures real-time images when hit or vibrated.

### BRIEF DESCRIPTION OF THE DRAWINGS

Objectives, features, and advantages of the present invention are hereunder illustrated with a preferred embodiment in conjunction with the accompanying drawing, in which:

FIG. 1 is a schematic view of a preferred embodiment of the present invention.

### DETAILED DESCRIPTION OF THE PREFERRED EMBODIMENTS

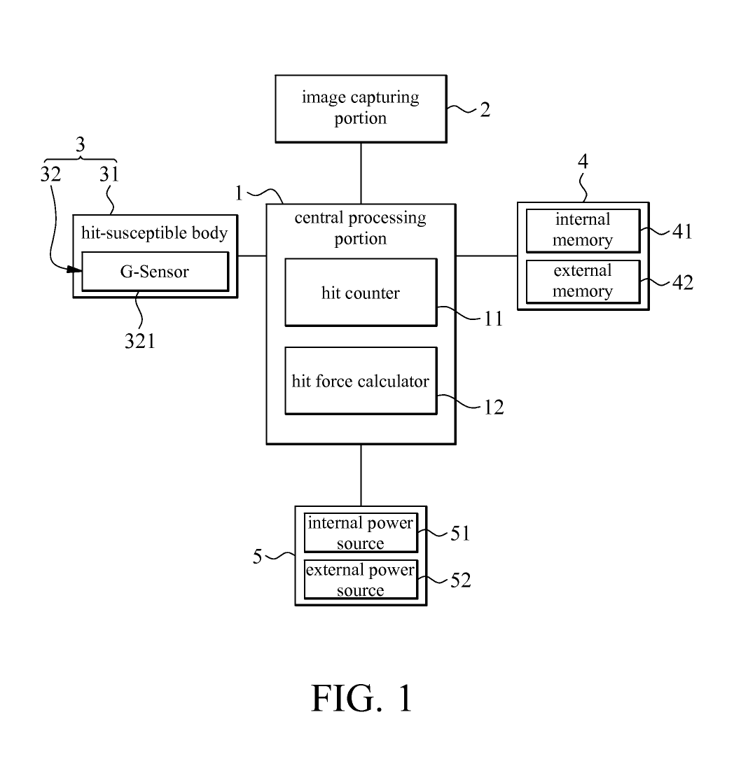

Referring to FIG. 1, the present invention provides a hit-triggered image capturing device, which is exemplified by a cellular phone, a digital camera, a digital camcorder, a car camcorder or a life camcorder. The hit-triggered image capturing device of the present invention comprises a central processing portion 1, an image capturing portion 2, a hit-susceptible portion 3, a memory portion 4 and a power supply portion 5. The central processing portion 1 is exemplified by a central processing unit (CPU) for calculating and processing image data entered with the other electronic components or the other electronic data and then sending the calculated and processed image data or electronic data to the other electronic components. The image capturing portion 2 is electrically connected to the central processing portion 1. The image capturing portion 2 is exemplified by a charge-coupled device (CCD) or a complementary metal-oxide-semiconductor (CMOS). The image capturing portion 2 captures an external image to thereby form static image data or dynamic image data and then sends the static image data or dynamic image data to the central processing portion 1 for calculation and processing. The hit-susceptible portion 3 comprises a hit-susceptible body 31 and a vibration sensing unit 32 (such as G-Sensor 321). The hit-susceptible body 31 is exemplified by any portion of a casing of the hit-triggered image capturing device of the present invention. Preferably, the hit-susceptible body 31 is any portion of the side or back of the casing so as to be easily hit. The vibration sensing unit 32 is fixed in place inside the hit-susceptible body 31 and electrically connected to the central processing portion 1 to thereby start the image capturing portion 2. Preferably, the hit-susceptible body 31 is of high rigidity. Hence, when the hit-susceptible body 31 is hit, the hitting force is conveyed to the vibration sensing unit 32 so as to sense hit force-related data precisely, and then the hit force-related data is sent to the central processing portion 1 to allow the central processing portion 1 to precisely drive the image capturing portion 2 to capture an external image according to the hit force-related data. The memory portion 4 is exemplified by a memory. The memory portion 4 is electrically connected to the central processing portion 1 to store image data retrieved by the image capturing portion 2 or the other electronic data. The power supply portion 5 is electrically connected to the central processing portion 1 to thereby supply power to all the aforesaid electronic components.

As described before, at the point in time when it shuts down, enters into a standby mode, or starts, the hit-triggered image capturing device of the present invention undergoes the following change: hitting the hit-susceptible body 31 to thereby drive the image capturing portion 2 to capture external real-time images especially about a moving scene or an instantaneous event. In addition, when the hit-triggered image capturing device of the present invention is subjected to vibration, the vibration sensing unit 32 drives the image capturing portion 2 to capture external real-time images.

Referring to FIG. 1, as regards the hit-triggered image capturing device, the central processing portion 1 comprises a hit counter 11. Therefore, the hit-triggered image capturing device of the present invention works in a manner that the hit counter 11 counts the hits to thereby perform various functions, including taking a picture in case of a hit, shooting a video in case of two hits, or vice versa.

Referring to FIG. 1, as regards the hit-triggered image capturing device, the central processing portion 1 comprises a hit force calculator 12. Therefore, the hit-triggered image capturing device of the present invention uses the hit force calculator 12 to calculate the hit force in order to perform various functions, including taking a picture in case of a small hit force, shooting a video in case of a large hit force, or vice versa, wherein the strength of the hit force is set to a default numerical range.

Referring to FIG. 1, as regards the hit-triggered image capturing device, the memory portion 4 comprises an internal memory 41, an external memory 42 (such as a USB flash drive or a memory card), or a combination thereof.

Referring to FIG. 1, as regards the hit-triggered image capturing device, the power supply portion 5 comprises an internal power source 51 (such as a secondary battery), an external power source 52 (such as a grid power connector), or a combination thereof.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A hit-triggered image capturing device, comprising:
a central processing portion;
an image capturing portion electrically connected to the central processing portion;
a hit-susceptible portion comprising a hit-susceptible body and a vibration sensing unit, wherein the vibration sensing unit is fixed to the hit-susceptible body and electrically connected to the central processing portion to thereby start the image capturing portion;
a memory portion electrically connected to the central processing portion to store images captured by the image capturing portion; and
a power supply portion electrically connected to the central processing portion.

2. The hit-triggered image capturing device of claim 1, wherein the central processing portion comprises a hit counter.

3. The hit-triggered image capturing device of claim 1, wherein the central processing portion comprises a hit force calculator.

4. The hit-triggered image capturing device of claim 2, wherein the central processing portion comprises a hit force calculator.

5. The hit-triggered image capturing device of claim 1, wherein the memory portion comprises one of an internal memory, an external memory and a combination thereof.

6. The hit-triggered image capturing device of claim 2, wherein the memory portion comprises one of an internal memory, an external memory and a combination thereof.

7. The hit-triggered image capturing device of claim 3, wherein the memory portion comprises one of an internal memory, an external memory and a combination thereof.

8. The hit-triggered image capturing device of claim 4, wherein the memory portion comprises one of an internal memory, an external memory and a combination thereof.

9. The hit-triggered image capturing device of claim 1, wherein the power supply portion comprises one of an internal power source, an external power source and a combination thereof.

10. The hit-triggered image capturing device of claim 2, wherein the power supply portion comprises one of an internal power source, an external power source and a combination thereof.

11. The hit-triggered image capturing device of claim 3, wherein the power supply portion comprises one of an internal power source, an external power source and a combination thereof.

12. The hit-triggered image capturing device of claim 4, wherein the power supply portion comprises one of an internal power source, an external power source and a combination thereof.

13. The hit-triggered image capturing device of claim 1, wherein the vibration sensing unit is a G-Sensor.

14. The hit-triggered image capturing device of claim 2, wherein the vibration sensing unit is a G-Sensor.

15. The hit-triggered image capturing device of claim 3, wherein the vibration sensing unit is a G-Sensor.

16. The hit-triggered image capturing device of claim 4, wherein the vibration sensing unit is a G-Sensor.
